(19) United States
(12) Patent Application Publication
(10) Pub. No.: US 2025/0124591 A1
(43) Pub. Date: Apr. 17, 2025

(54) IMAGE ANALYSIS WITH EPIPOLAR INFORMATION

(71) Applicant: Siemens Healthineers AG, Forchheim (DE)

(72) Inventors: Maximilian Rohleder, Erlangen (DE); Björn Kreher, Bräuningshof (DE)

(21) Appl. No.: 18/905,818

(22) Filed: Oct. 3, 2024

(30) Foreign Application Priority Data
Oct. 11, 2023 (DE) 10 2023 209 950.0

(51) Int. Cl. G06T 7/60; G06V 10/77; G06V 10/82

(52) U.S. Cl. CPC G06T 7/60; G06V 10/7715; G06V 10/82; G06T 2207/10081; G06T 2207/10116; G06T 2207/10132; G06T 2207/20081; G06T 2207/20084

(57) ABSTRACT

A method for providing a more reliable image analysis includes providing a first image of an object from a first perspective and providing a second image of the object from a second perspective. The method further includes: forming a first feature map from the first image in an encoding layer of a convolutional neural network; acquiring a feature in the first feature map; generating an epipolar information item regarding the acquired feature for the second perspective; introducing the epipolar information item into a decoding layer of the convolutional neural network; and decoding second feature maps of the second image including the epipolar information item by the decoding layer in order to obtain a second analysis image from the second image.

The present patent document claims the benefit of German Patent Application No. 10 2023 209 950.0, filed Oct. 11, 2023, which is hereby incorporated by reference in its entirety.

### TECHNICAL FIELD

The present disclosure relates to a method for image analysis by way of providing a first image of an object from a first perspective and a second image of the object from a second perspective as well as images of a first feature map in an encoding layer of a convolutional neural network from the first image. The present disclosure further relates to a corresponding image analysis apparatus and a corresponding computer program.

### BACKGROUND

The image analysis and, in particular, the identification (detection), segmentation, or regression of landmarks/objects in X-ray images is difficult in transmission imaging due to the translucent nature of materials. Large attenuation gradients, severely attenuating objects, and different dose values cover and blur regions of interest and impede the effectiveness of image processing methods.

In cone beam computed tomography (CBCT) imaging, during a 3D scan, a series of projection images is recorded. An example of the use of segmentation, (in particular, pixel-wise classification of associated regions), in the projection region is algorithms for reducing metal artifacts, which relate to the segmentation of metal in the projection images. Depending upon the recording direction, the image quality varies, which may lead to a failure of the algorithm. Thus, for example, lateral projection images (LAT; recorded from the side of the body) of the cervical spine are difficult to process due to the sharp attenuation gradients between the shoulder and lung regions. The shoulder region that absorbs the radiation, appears light, whereas the adjacent lung region has a low attenuation and appears dark. This sharp illumination gradient within an image does not occur, for example, in anterior-posterior (AP) thoracic imaging (recorded from front to back), because the anatomy here is more evenly radiation-attenuating.

Current methods for segmentation, regression, or identification in the projection region observe each projection image individually and leave the information of other existing images that show the same 3D object from another projection direction out of consideration. This leads to a performance deficiency and partially hinders this method being able to be used in X-ray systems. In relation to the above example, this may mean that a metal segmentation algorithm may fail for LAT images, whereas for AP images, it may function without any problems.

DE 10 2021 202 784 B4 describes a method in which a plurality of 2D projection images are obtained. The plurality of 2D projection images are linked to a plurality of views of a scene. The method also involves the determination, using at least one algorithm on the basis of a neural network, of a plurality of 2D segmentations of a region of interest in the scene for the plurality of 2D projection images. The method also includes the determination of a view consistency between the 2D segmentations that are associated with the plurality of views, based upon a pre-defined registration of the plurality of views. In particular, the 2D projection images may be medical images of a patient.

### SUMMARY AND DESCRIPTION

The object of the present disclosure relates to making an image analysis more reliable.

According to the disclosure, this object is achieved with a method and an image analysis apparatus as disclosed herein. The scope of the present disclosure is defined solely by the appended claims and is not affected to any degree by the statements within this summary. The present embodiments may obviate one or more of the drawbacks or limitations in the related art.

Accordingly, a method for image analysis is provided with the present disclosure, in particular for the medical sector or technical investigations.

In a first act of the method, the provision of a first image of an object from a first perspective and of a second image of the object from a second perspective takes place. Therefore, the same object is represented pictorially from two different perspectives. For example, a patient is trans-irradiated from the front and from the side. Two images from different perspectives result therefrom. In each perspective, for example, the spine may be visible. Each perspective is characterized by the respective recording geometry. In X-ray imaging, for example, the recording geometry is determined through the position and angle of the radiation source and the detector.

In a further act of the method, the imaging of a first feature map takes place in an encoding layer of a neural convolution network from the first image. A plurality of feature maps may be formed. One or more feature maps may be generated from the first image in the encoding layer and/or the convolution layer of the convolutional neural network (CNN). In certain examples, a feature map is generated for each scaling level.

In a further act, a feature is acquired in the first feature map. The feature may be a pixel or a pixel group which has, for example, a particular brightness. This may be, for instance, the tip of a screw.

In a further method act, a generation of an epipolar information item regarding the acquired feature for the second perspective is carried out. The epipolar geometry or the nuclear radiation geometry is a mathematical model of the geometry that represents the geometric relationships between differently oriented mappings of the same object. A geometric relationship of this type between the first image and the second image is to be used on the basis of the first perspective for the second perspective or for a second analysis image resulting therefrom. The epipolar information relates to the acquired feature which has been extracted from the first image or from a first feature map formed therefrom. Thus, an additional information item from the first image may be used to obtain an analysis image from the second image.

An introduction of the epipolar information into a decoding layer of the convolutional neural network takes place. The epipolar information item is thus used within the convolutional neural network. It is used, in particular, in the decoding layer. Thereby, the epipolar information item may be integrated into the deconvolution process.

Finally, in the method, a decoding of one or more second feature maps of the second image including the epipolar information item takes place by the decoding layer in order to obtain a second analysis image from the second image. The second feature map(s) originate from the encoding layer of the convolutional neural network if the second image is encoded. However, for decoding, not only the second feature map(s) are used, but also the epipolar information item which defines the relationship between the first image and the second image. With this additional information, a more informative second analysis image may be obtained.

The introduction of the epipolar information item into the decoding layer may be realized by an operator. The operator maps an image transformation (e.g., a (differentiable image transformation) that registers and converts the feature space of a convolutional layer according to a known geometry onto a second projection. An advantageous realization of this operator would be the implementation on a graphics card (GPU) since in this way, the conversion of many channels in parallel is enabled. The CNN may thus distribute the feature information into channels of the feature map and incorporate it while taking account of the epipolar information item in the processing of a second projection (second image). Apart from a large number of feature maps, the implementation on the GPU also enables a high spatial resolution which enables the processing of full-resolution X-ray images (e.g., 976×976 pixels) effectively in real time. A further characteristic may be the analytical derivation of the gradient, which would be necessary in order to create the differentiability and use with gradient-based optimization (gradient back-propagation).

In the article by O. Ronneberger et al., “U-Net: Convolutional networks for biomedical image segmentation,” Proc. MICCAI, pp. 234-241, Springer International Publishing, Cham (2015), a convolutional neural network (CNN) with U-Net architecture is described.

In one embodiment, the image analysis includes a segmentation, a regression, and/or a detection. In the segmentation, the image analysis aims to classify regions of the image. In particular, the classification may take place pixel-wise. It is thus possible to recognize in an image, for example, a region that reproduces a metallic object. Regression may be the approximation to a continuously distributed variable, (e.g., per pixel in the image processing). One example is the path length estimate per pixel. During the detection, for example, a predetermined object type is recognized.

In a further embodiment, for the introduction of the epipolar information item into the decoding layer, a differentiable operator is used. The differentiable operator is a precondition for the convolutional neural network being capable of learning. Specifically, with the differentiable operator, a gradient image may be generated from an error image during training.

In another embodiment, the epipolar information item contains a line which results from a first ray from the feature to a ray source in the first perspective and a ray geometry of the second perspective. The epipolar information item, in this case the line, represents a space-dependent conditional information item. It is based on the ray geometry of the ray from the ray source to the acquired feature in the first perspective.

In a further development, the line corresponds to a section line that results from an epipolar plane that extends through the ray source in the second perspective parallel to the first ray, intersected by a second image plane in the second perspective. Thus, not only the ray source lies in the epipolar plane in the second perspective, but also the first ray and thus also the ray source in the first perspective. This epipolar plane intersects the image plane of the second image (second image plane) in the second perspective. The intersection of the two planes results in a line in the second image plane. This line represents an epipolar line. The object that has led to the acquired feature in the first image plane (image plane of the first image), seen from a perspective standpoint, lies on it. Thus, for example, faulty segmentations may be reduced since with the epipolar line, the space occupied by the acquired feature in the second image is reduced.

According to a further embodiment, the epipolar information item is generated in a separate feature map that is fed to another feature map in the decoding layer when it is introduced into the decoding layer. For example, from the operator for the perspective translation as a feature map, just one line is produced in the 2D space. This feature map with the line may simply be added to another feature map of the decoding layer. The feature map arising as a total then additionally contains the epipolar information item. Alternatively, the feature maps may also be concatenated, in particular along the channel dimension.

In an embodiment, the first perspective is orthogonal to the second perspective. An angular range from 80 to 110 degrees may be regarded as substantially orthogonal or perpendicular. In certain examples, images are used, the perspectives of which are rotated by 90 degrees. With such orthogonal perspectives, a very high additional information gain may be assumed.

In one embodiment, the convolutional neural network has a U-Net architecture. A U-Net of this type is based upon a complete convolution network (fully convolutional neural network) that shows particular speed advantages during training and segmentation.

In a further embodiment, in each of a plurality of scaling levels of the decoding layer, an epipolar information item is taken into account. If the convolutional neural network has, for example, five scaling levels from 32² to 512², then epipolar information may be introduced into each of the middle three scaling levels. The epipolar information items are specific, in each case, to their scaling levels. Thus, in a decoding procedure with a plurality of decoding steps (decoding step sequence) a plurality of additional epipolar information items may be introduced.

In an embodiment, the first image and the second image may each be an X-ray image or a sonography image. Both X-ray images and sonography images may be recorded in different perspectives in order to generate corresponding analysis images therefrom. Although in X-ray images the object may be arranged between the radiation source and the detector, in sonography recordings, the radiation source and the detector may be arranged on the same side of the object in order to record reflections.

In another embodiment, the two images are obtained by way of a C-arm device or a CT scanner with X-ray technology. Therein, numerous images are recorded from different angles round the respective object. For example, 400 projection recordings of an object are thus obtained from different angles. In order to make use of the method, from this large number of recordings, an image pair is selected, wherein the individual images may have been obtained from perspectives 90 degrees apart.

In a further embodiment, the first image is encoded in the convolutional neural network, and, in a first decoding step sequence, the first image is decoded to a first analysis image. Additionally, the second image is encoded in the convolutional neural network, and, in a second decoding step sequence, the second image is decoded to the second analysis image. Further, in the first decoding step sequence and the second decoding step sequence, the decoding layer exchanges epipolar information items alternatingly. This means that epipolar information that has been gathered on the basis of a feature of the first image is used during decoding of the second image or of the second analysis image and vice versa. In this way, from the two original images, two high-quality analysis images with different recording angles are formed.

Furthermore, a method for training the convolutional neural network for an aforementioned image analysis method may be provided, wherein by way of the aforementioned differentiable operator, a gradient image is generated during training. The operator is thus fed, for example, with an error image and therefrom generates a gradient image that may be used for the optimization of the weights. The CNN may be trained on the basis of a plurality of training datasets, wherein each of the training datasets contains a plurality of 2D projection images with an annotated ground truth.

The aforementioned object is also achieved by way of an image analysis apparatus for image analysis. The image analysis apparatus may include an input facility (e.g., memory store, interface) configured to provide a first image of an object from a first perspective and a second image of the object from a second perspective. The image analysis apparatus may further include a computing facility configured to: form a first feature map in an encoding layer (convolution layer) of a convolutional neural network (CNN) from the first image; acquire a feature in the first feature map; generate an epipolar information item regarding the acquired feature for the second perspective; introduce the epipolar information item into a decoding layer (deconvolution layer) of the convolutional neural network; and decode second feature maps of the second image including the epipolar information item by the decoding layer in order to obtain a second analysis image from the second image.

The input facility may have a memory store and/or an interface with which the respective images may be provided. The computing facility may have one or more processors and one or more storage elements.

The developments and advantages set out in relation to the method apply similarly also for the image analysis apparatus as disclosed herein. The respective method features may be regarded as corresponding functional features of the image analysis apparatus.

Furthermore, a computer program or a computer program product is provided which has commands which, when they are executed in an image analysis apparatus described above, enable it to carry out a method also described above.

For application cases or application situations that may arise with the method, and which are not explicitly described here, an error message and/or a request for input of a user feedback may be output and/or a standard setting and/or a predetermined initial state may be set.

### BRIEF DESCRIPTION OF THE DRAWINGS

The present disclosure is now described in greater detail making reference to the accompanying drawings, in which:

FIG. 1 depicts a schematic view of an embodiment of an image analysis apparatus.

FIG. 2 depicts an example of a simplified graphical reproduction of an operator for epipolar perspective translation.

FIG. 3 depicts an example of a two-perspective architecture for epipolar perspective translation.

### DETAILED DESCRIPTION

The present disclosure is based, in one exemplary embodiment, upon an operator for the image translation which performs a perspective transformation of an image onto another image with a known recording geometry. The recording or view geometry (epipolar geometry) may be derived directly from available projection matrices. On the basis of this known geometric relationship, a so-called consistency condition may be formulated. This condition describes intuitively where a point feature of a first image (e.g., the tip of a screw) is located in a second image. The proposed image translation operator calculates these locations and generates an additional feature map which (put simply) may be laid over the second image. This feature map is then used as additional knowledge in the processing of the second image.

This operator is to be implemented as a differentiable function, which enables it to become embedded in the graphs of a deep learning model architecture. Thus, the feature maps calculated by a convolutional neural network (CNN) may be translated into the perspectives of another projection image. By way of the simultaneous processing of a plurality of images of the same scene, with a synchronous forward pass through the model, spatially registered feature maps may be exchanged between the two model predictions. With this capability, a CNN model may predict images that match better with other views of the same scene.

For example, the insufficient information may be enhanced on the basis of the low image quality in LAT images with feature information from AP images. Thus, a model may also recognize objects in heavily covered image regions.

The strength of the operator lies in being able to process so-called multi-view images conditionally and jointly. Multi-view images are effectively views of an identical unchanged scene. Applied to medical imaging, this may be the X-ray images of a CBCT scan. The recording geometry is also known, and thus both the pose of the source-detector apparatus (e.g., in global coordinates) as well as the intrinsic factors of the X-ray system. This information may be derived from the projection matrices of the CBCT scan or is calculable from the angle measuring units of the C-arm system. It is therefore the case that the exactness of the angle measurement, the calibration, etc., naturally influences the usability of the operator.

The operator is therefore readily usable given such datasets/problems, where these multi-view images and geometric localization are present. The use may be the segmentation of metal objects in a plurality of 2D X-ray images or the detection of 3D landmarks (e.g., catheter wire tip, anatomical landmarks) or the “inpainting” (e.g., graphical insertion) of 3D structures (e.g., screws). In principle, any use in which a plurality of images of the same scene are recorded is imaginable.

A CNN model that is equipped with this operator may then initially extract features from one view, convert it geometrically and pass the processing to a second view. The converted feature maps are concatenated along the channel dimension with the features of the second view and act effectively as additional conditioning information. The main difference from existing segmentation methods lies therein that the information from other views is not only made available but is also spatially registered according to the known geometry.

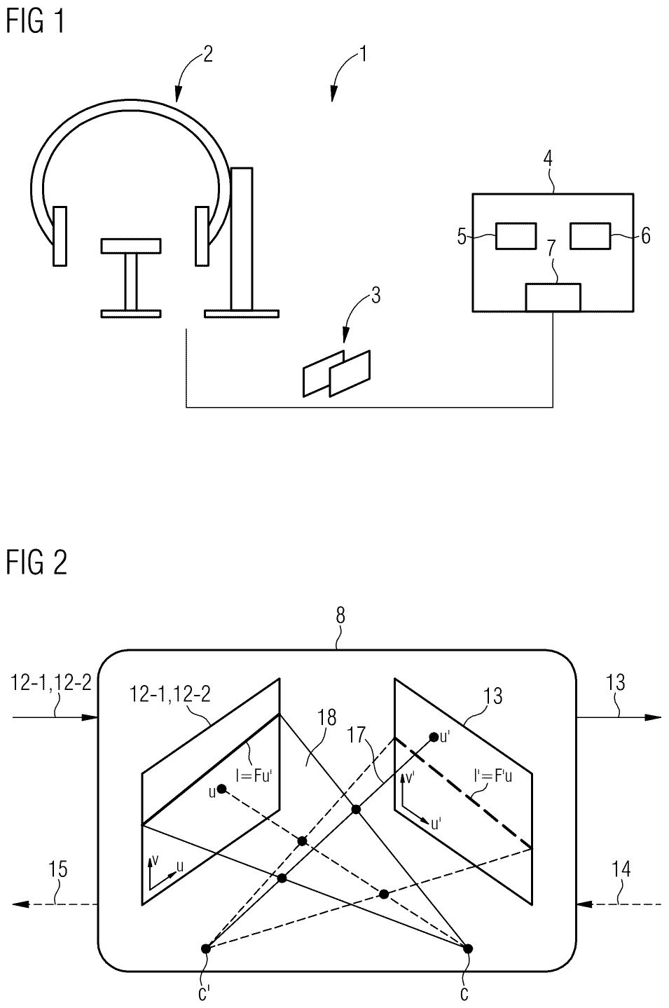

FIG. 1 shows a schematic representation of a system 1. The system 1 has an imaging facility 2, for example, an X-ray C-arm. A plurality of 2D projection images 3 is recorded with the aid of the imaging facility 2 and provided to an image analysis device 4. The image analysis device 4 has a processor or a computing facility 5 and a memory store 6. The computing facility 5 may receive the 2D projection images 3 via an interface 7 and may process the 2D projection images 3. For the processing of the 2D projection images 3, the computing facility 5 may load and execute program code from the memory store 6.

The projection images 3 may be processed during a training phase and/or an inference phase of a CNN, which may be carried out by the computing facility 5 after the loading of program code from the memory store 6.

In a training phase, a CNN may be trained for the processing of 2D projection images. For this purpose, an iterative numerical optimization may be implemented. The parameters of a plurality of layers of the CNN may be adapted in each iteration of the numerical iterative optimization. This may take place in order to minimize a value of a cost function. The value of the cost function may be determined on the basis of a loss function. The value of the cost function may depend upon the difference between a prediction of the CNN and the actual ground truth labels. The ground truth labels may be determined manually. For example, a gradient descent method may be used to change the parameters of the CNN. Backward propagation may be utilized.

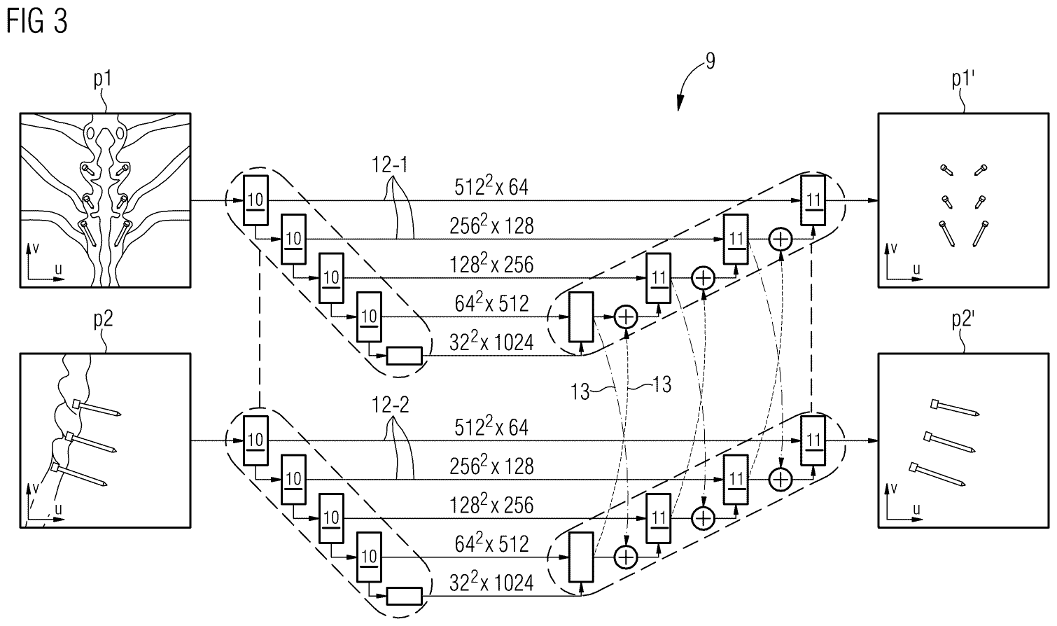

In relation to FIGS. 2 and 3, a specific exemplary embodiment for the method is now described. In particular, the epipolar consistency is integrated into the analysis or segmentation process itself rather than formulating a postprocessing act.

Proceeding from two projection images (e.g., first image p1 and second image p2, see FIG. 3) with known recording geometry, the exemplary method segments these images p1, p2 together and with knowledge of their three-dimensional geometric relationship. For this purpose, a learning segmentation model is made able to draw knowledge from the epipolar geometry into its prediction. A differentiable image translation operator 8 is embedded into the model architecture 9, which translates the intermediate segmentation results between the views so that the model may adapt its predictions to this conditional information.

The aim of the following embodiment is to provide a neural network with spatially registered feature information from a second view with known geometry. Dependent upon the task, the signals of the second view may have both a disrupting as well as a supporting effect. In order to embed this operator in the model architecture and to use it with gradient-based optimization, an analytical gradient is derived in relation to the entry. Because the operator describes a complex perspective transformation, the automatic differentiation functions of common frameworks cannot be used.

A projection matrix encodes the geometry of an image recording system and may be available for CBCT scans. Conceptionally, such a matrix encodes the position of the X-ray radiation source-detector system and the intrinsic perspective or observation parameters such as the spacing between the source and the detector, and the conical beam angle. This non-linear projective transformation maps a point in homogeneous 3D world coordinates onto a pixel u in the detector coordinates.

The so-called epipolar geometry is shown in FIG. 2. FIG. 2 also shows the proposed perspective translation operator which is designated the image translation operator 8 in the present document. The intrinsic relationship between two images p1 and p2 (see FIG. 3) in corresponding projections is compactly acquired in a fundamental matrix F. It directly encodes the inherent geometric relationship between two detector coordinate systems u, v; or u′, v′ and may be derived from two given projection matrices. Ray paths begin at respective ray sources c, c′. A ray 17 from one radiation source c′ to the point feature u′ lies in an epipolar plane 18 in which the other radiation source c also lies. This epipolar plane 18 intersects the image plane of the feature map 12-1, 12-2 at a line l (epipolar information). A similar principle applies for the ray geometry or the point feature u.

In a forward run through, a point u′ in an epipolar map 13 is calculated by way of integration along the epipolar line l=Fu′ in the feature map 12-1, 12-2. That is, the fundamental matrix F maps the point u′ onto the line l. The resultant vector l represents a straight line in the implicit null space. During the gradient backpropagation, the contribution of a point u in the feature map 12-1, 12-2 is determined by way of integration along its epipolar line in the error image 14. A corresponding gradient image 15 results.

Epipolar geometry stipulates that a 3D landmark that is recognized at a detector position u′ in the projective view (e.g. image p1) lies somewhere along the epipolar line l in the respective other view (e.g. image p2). This applies only for as long as the landmark is situated within the volume of interest (VOI) that is mapped by both views.

In order to acquire this geometric relationship and to make the consistency conditions resulting therefrom available to the model, the aforementioned epipolar map 13, (i.e., an epipolar feature map), may be calculated.

In order to embed the operator 8 into a model architecture 9, the gradient is calculated in relation to its inputs and all the trainable parameters. Because the proposed operator 8 contains no trainable parameters, only the gradient needs to be derived in relation to the input.

After the calculation of a loss L, this is traced backward (by backpropagation) by way of the computational graph. For the operator, the loss appears in relation to the predicted consistency map. From this image-like loss, the gradient is derived in relation to the input image.

With regard to FIG. 3, an exemplary two-perspective architecture 9 with epipolar perspective translations is now described. As a basis model, the popular U-Net architecture is utilized in its original configuration according to Ronneberger et al. As FIG. 3 shows, it has four encoding blocks 10 in the encoding layer, which reduce the spatial resolution by a factor of two in each case (downsampling). With input images having a size 512², this results in five scaling steps, the smallest being a feature map of the size 32². At the same time, each encoding block 10 increases the number of the extracted features, which is reflected in the channel dimensions from 64 in the first to 1024 in the last scaling step. In each scaling step, the encoding blocks 10 supply a respective first feature map 12-1 from the first image p1 and from the second image p2 in each scaling step, a respective second feature map 12-2. The model is enhanced with a mirrored decoding layer having four decoding blocks 11, which samples the low resolution features upwardly by way of transposed convolutions and refines them with higher resolution features which are available via skip connections.

The model architecture 9 integrates the perspective translation operator 8 as skip connections between the views. Each view or each image p1, p2 is routed individually through the model. In the decoding layer, the individual epipolar information items are fed by way of the operator 8 or the operators. The forward flowthrough is synchronized there and the translated feature maps of the two images p1 and p2 are daisy-chained. It should be noted that the same model is used for the processing of both views p1, p2, although it is represented in FIG. 3 as two separate models. This may be realized efficiently with the aid of the weight sharing.

In the existing example, the operator 8 is placed at three sites in the model 9, directly after each upsampling or decoding block 11, apart from the last. In FIG. 3, in the interests of the overview, in place of the operator, only the respective epipolar map 13 is drawn in, in each case, in the central scaling steps. After each decoding block 11, the respective feature map is additively overlaid with the corresponding epipolar map 13. In the respective decoding block 11, the feature maps 12-1, 12-2 are undoubtedly sparser. Intuitively, this increases the value of the proposed operator 8, because fewer objects are situated in the same epipolar plane and thus the correspondence may be derived more directly. At the end of the decoding layer, the respective segmentation or analysis image p1′, p2′ is the result.

It is to be understood that the elements and features recited in the appended claims may be combined in different ways to produce new claims that likewise fall within the scope of the present disclosure. Thus, whereas the dependent claims appended below depend on only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for image analysis comprises:
providing a first image of an object from a first perspective;
providing a second image of the object from a second perspective;
forming a first feature map in an encoding layer of a convolutional neural network from the first image;
acquiring a feature in the first feature map;
generating an epipolar information item regarding the acquired feature for the second perspective;
introducing the epipolar information item into a decoding layer of the convolutional neural network; and
obtaining a second analysis image from the second image by decoding second feature maps of the second image comprising the epipolar information item by the decoding layer.

2. The method of claim 1, wherein the image analysis comprises a segmentation, a regression, and/or a detection.

3. The method of claim 1, wherein a differentiable operator is used in the introducing of the epipolar information item.

4. The method of claim 1, wherein the epipolar information item comprises a line that results from a first ray from the feature to a ray source in the first perspective and a ray geometry of the second perspective.

5. The method of claim 4, wherein the line corresponds to a section line that results from an epipolar plane extending through the ray source in the second perspective parallel to the first ray, intersected by a second image plane in the second perspective.

6. The method of claim 1, wherein the epipolar information item is generated in a separate feature map fed to another feature map in the decoding layer when introduced into the decoding layer.

7. The method of claim 1, wherein the first perspective is orthogonal to the second perspective.

8. The method of claim 1, wherein the convolutional neural network has a U-Net architecture.

9. The method of claim 1, wherein a respective epipolar information item is taken into account for each scaling level of a plurality of scaling levels of the decoding layer.

10. The method of claim 1, wherein the first image and the second image are each an X-ray image or a sonography image.

11. The method of claim 10, wherein the first image and the second image are obtained with X-ray technology by way of a C-arm device or a CT scanner.

12. The method of claim 1, wherein the first image is encoded in the convolutional neural network,
wherein, in a first decoding step sequence, the first image is decoded to a first analysis image,
wherein the second image is encoded in the convolutional neural network,
wherein, in a second decoding step sequence, the second image is decoded to the second analysis image, and
wherein, in the first decoding step sequence and the second decoding step sequence, the decoding layer exchanges epipolar information items alternatingly.

13. A method for training a convolutional neural network, the method comprising:
providing a first image of an object from a first perspective;
providing a second image of the object from a second perspective;
forming a first feature map in an encoding layer of the convolutional neural network from the first image;
acquiring a feature in the first feature map;
generating an epipolar information item regarding the acquired feature for the second perspective;
introducing the epipolar information item into a decoding layer of the convolutional neural network using a differentiable operator;
obtaining a second analysis image from the second image by decoding second feature maps of the second image comprising the epipolar information item by the decoding layer; and
generating a gradient image during the training by way of the differentiable operator.

14. An image analysis apparatus for image analysis, the image analysis apparatus comprising:
an input facility configured to provide a first image of an object from a first perspective and a second image of the object from a second perspective; and
a computing facility configured to:
form a first feature map in an encoding layer of a convolutional neural network from the first image;
acquire a feature in the first feature map;
generate an epipolar information item regarding the acquired feature for the second perspective;
introduce the epipolar information item into a decoding layer of the convolutional neural network; and
obtain a second analysis image from the second image via decoding second feature maps of the second image including the epipolar information item by the decoding layer.
